(19) United States
(12) Patent Application Publication
(10) Pub. No.: US 2018/0247602 A1
(43) Pub. Date: Aug. 30, 2018

(54) LIQUID CRYSTAL DISPLAY

(71) Applicant: CHUNGHWA PICTURE TUBES, LTD., Taoyuan City (TW)

(72) Inventors: Chao-Jen CHANG, Taoyuan City (TW); Chih-Sheng HSU, Hsinchu County (TW); Chun-Yi HUANG, Taoyuan City (TW)

(21) Appl. No.: 15/613,125

(22) Filed: Jun. 2, 2017

(30) Foreign Application Priority Data
Feb. 24, 2017 (CN) 201720169728.6

(51) Int. Cl. G09G 3/36; G02F 1/1362; G02F 1/13; G02F 1/29; C09K 19/02

(52) U.S. Cl. CPC G09G 3/3607; G02F 1/136213; G02F 1/1303; G02F 2001/133311; G09G 3/3659; C09K 19/02; G02F 1/29

(57) ABSTRACT

A liquid crystal display includes a pixel array formed by a plurality of scanning lines and a plurality of data lines. Two of the scanning lines which are adjacent to each other and two of the data lines which are adjacent to each other form a pixel unit. The pixel unit includes a capacitor and a transistor. The transistor includes a control terminal, a first terminal, and a second terminal. When one of the scanning lines transmits a scanning signal to the control terminal of the transistor and turns on the transistor, one of the data lines charges the capacitor by transferring a data signal to the capacitor through the transistor, and the pixel unit still has a charging percentage greater than or equal to a charging percentage threshold when an ambient temperature is below a temperature threshold.

### CROSS-REFERENCE TO RELATED APPLICATION

This application claims the priority benefit of CHINESE Application serial no. 201720169728.6, filed Feb. 24, 2017, the full disclosure of which is incorporated herein by reference.

### FIELD OF INVENTION

The invention relates to a liquid crystal display. More particularly, the invention relates to a liquid crystal display for improving an image sticking phenomenon in low temperature.

### BACKGROUND

Liquid crystal displays are widely used in electronic devices such as laptops, smart phones, digital cameras, billboard displays and high resolution televisions. After the liquid crystal displays continue to display a static screen for a long time, the image or outline of the static screen may appears on the next screen when the next screen is displayed, that is, image sticking phenomenon.

Some methods have been proposed to improve the image sticking phenomenon at normal temperature. However, in a low temperature environment, the physical characteristics such as the electron mobility, the charging percentage and the liquid crystal rotation speed of the liquid crystal and/or the module are very different from those in the normal temperature environment, and the liquid crystal displays with good image sticking conditions in normal temperature usually have worse image sticking conditions in low temperature. Therefore, how to effectively improve the image sticking phenomenon in low temperature environment is one of the problems needed to be addressed in the art.

### SUMMARY

An embodiment of this disclosure is to provide a liquid crystal display. The liquid crystal display comprises a pixel array formed by a plurality of scanning lines and a plurality of data lines. Two of the scanning lines which are adjacent to each other and two of the data lines which are adjacent to each other form a pixel unit, and the pixel unit comprises a capacitor and a transistor. The transistor comprises a control terminal, a first terminal, and a second terminal. The control terminal is electrically connected to one of the scanning lines. The first terminal is electrically connected to one of the data lines. The second terminal is electrically connected to the capacitor. When one of the scanning lines transmits a scanning signal to the control terminal of the transistor and turns on the transistor, one of the data lines charges the capacitor by transferring a data signal to the capacitor through the transistor, and the pixel unit still has a charging percentage greater than or equal to a charging percentage threshold when an ambient temperature is below a temperature threshold.

The increase of the charging percentage of the capacitor is achieved by changing the pixel design parameters, the driving frequency and/or the positive voltage of the gate electrode, in order to improve the image sticking phenomenon of the liquid crystal display in low temperature.

### BRIEF DESCRIPTION OF THE DRAWINGS

FIG. 1 is a schematic diagram illustrating a liquid crystal display according to some embodiments of the present disclosure.

### DETAILED DESCRIPTION

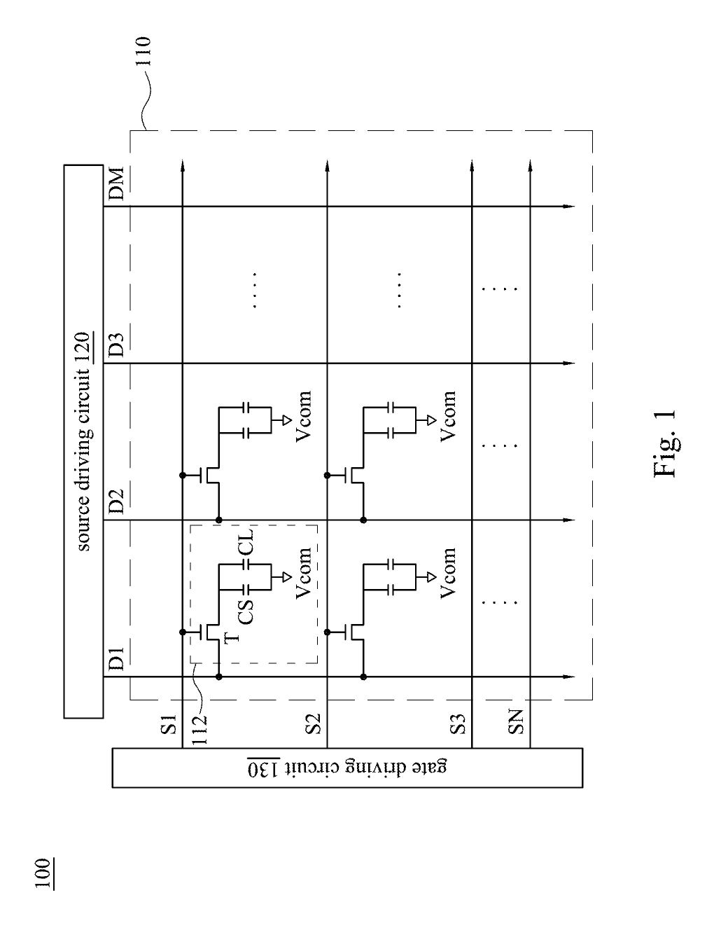

Reference is made to FIG. 1. FIG. 1 is a schematic diagram illustrating a liquid crystal display 100 according to some embodiments of the present disclosure. The liquid crystal display 100 includes a liquid crystal display panel 110, a source driving circuit 120, a gate driving circuit 130, a plurality of scanning lines S1 to SN and a plurality of data lines D1 to DM. N and M are positive integers. The source driving circuit 120 is configured to supply data signals through the data lines D1 to DM, and the gate driving circuit 130 is configured to supply the scanning signals through the scanning lines S1 to SN. The liquid crystal display 100 illustrated in FIG. 1 only shows part of the scanning lines and data lines for illustrative purposes only, and the present disclosure is not limited thereto.

As illustrated in FIG. 1, pixel cells are formed between two of the scanning lines which are adjacent to each other and two of the data lines which are adjacent to each other. The liquid crystal display panel 110 includes a plurality of pixel units arranged in a two dimensional series including a plurality of rows and columns. FIG. 1 only shows part of the pixel units for illustrative purposes, and the present disclosure is not limited thereto.

As illustrated in FIG. 1, in some embodiments, the pixel unit 112 includes a storage capacitor CS, a liquid crystal capacitor CL, and a transistor T. In some embodiments, the transistor T is a thin film transistor, and the present disclosure is not limited thereto. The transistor T includes a control terminal, a first terminal, and a second terminal. The control terminal is electrically connected to one of the scanning lines, the first terminal is electrically connected to one of the data lines, and the second terminal is electrically connected to the storage capacitor CS and the liquid crystal capacitor CL. The storage capacitor CS and the liquid crystal capacitor CL are connected to the common voltage Vcom.

In some embodiments, when the scan line S1 transmits the scanning signal to the control terminal of the transistor T and turns on the transistor T, the data line D1 transfers the data signal to the storage capacitor CS and/or the liquid crystal capacitor CL via the transistor T to charge the storage capacitor CS and/or liquid crystal capacitor CL. The storage capacitor CS stores the data voltage of the data signal transmitted by the data line D1, and the data voltage stored in the liquid crystal capacitor CL may be stabilized when the scanning line S1 does not provide the scanning signal.

When the liquid crystal display 100 displays a static screen for a long period of time, the image or outline of the static screen appears on the screen when the next screen is displayed, that is, the image sticking phenomenon. Some methods have been proposed for improving the image sticking phenomenon, for example, by means of a control circuit or an alignment film to improve the image sticking phenomenon. However, these methods are only for the condition that the ambient temperature is normal temperature. In low temperature, physical properties such as electron mobility, charging percentage, and liquid crystal rotation speed of liquid crystal and/or components are very different from those in the normal temperature environment, and liquid crystal displays with good image sticking conditions in normal temperature usually have worse image sticking conditions in low temperature.

In the present disclosure, when the ambient temperature is lower than the temperature threshold, the charging percentage of the storage capacitor CS and/or the liquid crystal capacitor CL is still greater than or equal to the charging percentage threshold, in order to effectively improve the low temperature image sticking phenomenon of the liquid crystal display 100.

In some embodiments, the charging percentage threshold is between about 90% and 99%. In some embodiments, the temperature threshold is between about −20 degrees Celsius and −40 degrees Celsius. The present disclosure is not limited thereto.

In some embodiments, the increase of the charging percentage of the storage capacitor CS and/or the liquid crystal capacitor CL is achieved by changing the pixel design parameters, the driving frequency and/or the positive voltage of the gate electrode, in order to improve the image sticking phenomenon of the liquid crystal display 100 in low temperature.

In some embodiments, the image sticking phenomenon is tested by performing a image sticking condition on the liquid crystal display 100. The image sticking condition includes the following operations. Displaying the test screen on the liquid crystal display 100 and maintaining for a period of time, changing the screen displayed on the liquid crystal display 100 to a gray level screen, and detecting the presence time of the image sticking on the liquid crystal display 100. However, there are various methods for testing the image sticking phenomenon. The image sticking condition proposed here is for illustrative purposes, and the present disclosure is not limited thereto.

In some embodiments, the gray level of the gray level screen is between the minimum gray level and the maximum gray level of the liquid crystal display 100. In some embodiments, for example, the gray level screen may be a gray level of 128.

In some embodiments, even if the liquid crystal display 100 is in a condition that the ambient temperature is lower than the temperature threshold, the presence time of the image sticking on the liquid crystal display 100 is less than the time threshold. That is, the image sticking on the liquid crystal display 100 of the present disclosure disappears within a short period of time. In general, after the testing of the image sticking phenomenon of the liquid crystal display 100 is performed, the acceptable level of the presence time of the image sticking is less than five minutes. Thus, in some embodiments, the time threshold may be set to 5 minutes, but the present disclosure is not limited thereto.

In some embodiments, the realization of the charging percentage of the storage capacitor CS and/or the liquid crystal capacitor CL reaching the charging percentage threshold in the low temperature environment is achieved by the parameter design of the transistor T in the pixel unit 112. In some embodiments, the ratio of the channel width to the channel length of the transistor T is 40.728/3.5. Table 1 shows the test results of the presence time of the image sticking at which the liquid crystal display 100 is tested when the ambient temperature is in normal temperature and when the ambient temperature is lower than the temperature threshold.

TABLE 1

| | | | image sticking phenomenon | | |
|---|---|---|---|---|---|
| | charging percentage | | | | testing |
| model | 25° C. | −30° C. | 25° C. | −30° C. | condition |
| A | 100% | 98.75% | immediately | immediately | 128 gray |
| | | | disappeared | disappeared | level |
| A | 100% | 98.75% | immediately | immediately | any gray |
| | | | disappeared | disappeared | level |
| B | 99.17% | 84.48% | immediately | 10 minutes | 128 gray |
| | | | disappeared | level | |

The model A in Table 1 is an example of the liquid crystal display 100 according to some embodiments. The ratio of the channel width to the channel length of the transistor T of the model A is 40.728/3.5. And the liquid crystal display 100 of the model B is used as a control. The liquid crystal display 100 of the model B and the liquid crystal display 100 of the model A have the same material composition for the color filter, the panel assembly and the transistor T. Only the design parameters of the transistor T in the cell 112 are different between the liquid crystal display 100 of the model B and the liquid crystal display 100 of the model A. The ratio of the channel width to the channel length of the transistor T of the model B is 17.728/3.5.

As shown in Table 1, in normal temperature, the charging percentage of the liquid crystal display 100 of the model A and the liquid crystal display 100 of the model B reaches 99.17% or more, so that the image sticking on the liquid crystal display 100 of the model A and the liquid crystal display 100 of the model B immediately disappears during the image sticking test with 128 gray level. However, when the temperature is lower than the temperature threshold (for example, −30 degrees Celsius), only the charging percentage of the liquid crystal display 100 of the model A reaches 98.75%, by contrast, the charging percentage of the liquid crystal display 100 of the model B may only reach 84.48%. The image sticking of the liquid crystal display 100 of the model A immediately disappears when the image sticking test is performed with 128 gray level, by contrast, the image sticking of the liquid crystal display 100 of the model B disappears after 10 minutes. As can be seen from above, in a low temperature environment (for example, −30 degrees Celsius), when the charging percentage reaches 98.75% or more, the image sticking disappears immediately, that is, the presence time of the image sticking is less than the set time threshold (for example, 5 minutes). According to the above experimental results, the charging percentage threshold may be set to 98.75%, so that the image sticking immediately disappears.

In addition, when the ambient temperature is lower than the temperature threshold (for example, −30 degrees Celsius), the charging percentage of the model A may reach at least 98.75%. At this time, regardless of the gray level of the gray level screen used to test the model A, the image sticking on the liquid crystal display 100 of the model A immediately disappears.

In some embodiments, the charging percentage of the storage capacitor CS and/or the liquid crystal capacitor CL in the low temperature environment is achieved by increasing the charging percentage threshold by increasing the positive voltage of the gate electrode of the scanning lines S1 to SN. Table 2 shows the test results of the presence time of the image sticking at which the liquid crystal display 100 is tested with the ambient temperature in normal temperature and with the ambient temperature lower than the temperature threshold.

TABLE 2

| | | positive | | | | | |
|---|---|---|---|---|---|---|---|
| | | voltage | | | | | |
| | | of the | charging | | image sticking phenomenon | | |
| | driving | gate | percentage | | | | testing |
| model | frequency | electrode | 25° C. | −30° C. | 25° C. | −30° C. | condition |
| B | 60 Hz | 22 V | 99.17% | 84.48% | immediately | 10 minutes | 128 gray |
| | | | | | disappeared | | level |
| | 60 Hz | 28 V | 100% | 90.00% | immediately | 3 minutes | 128 gray |
| | | | | | disappeared | | level |
| | 60 Hz | 36 V | 100% | 98.73% | immediately | immediately | 128 gray |
| | | | | | disappeared | disappeared | level |
| | 60 Hz | 36 V | 100% | 98.73% | immediately | immediately | any gray |
| | | | | | disappeared | disappeared | level |

As shown in Table 2, in normal temperature, different positive voltages of the gate electrode is applied to the liquid crystal display 100 of the model B, and the charging percentage of the liquid crystal display 100 of the model B reaches 99.17% or more, so that the image sticking on the liquid crystal display 100 of the model B immediately disappears during the image sticking test with 128 gray level. However, when the temperature is lower than the temperature threshold (for example, −30 degrees Celsius), 28V (Voltage) of the positive voltage of the gate electrode or more is applied to the model B so that the charging percentage of the model B in the low temperature environment reaches 90% or more, and only at this time, the presence time of the image sticking on the model B may be less than the time threshold (for example, 5 minutes). It may be seen from the above, in the low temperature environment, when the charging percentage reaches 90% or more, the presence time of the image sticking may be less than the time threshold (for example, 5 minutes). Therefore, the charging percentage threshold in the low temperature environment may be set to 90%, so that the presence time of the image sticking is less than the time threshold (for example, 5 minutes).

In addition, as shown in Table 2, when the temperature is lower than the temperature threshold (for example, −30 degrees Celsius), if 36V (Voltage) of the positive voltage of the gate electrode is applied to the model B, the charging percentage of the liquid crystal display 100 of the model B reaches more than 98.73%, so that the image sticking immediately disappears during the image sticking test with 128 gray level. In addition, if 36V of the positive voltage of the gate electrode is applied to the model B, the image sticking of the liquid crystal display 100 of the model B immediately disappears regardless of the gray level of the gray level screen used during the test. According to the above experimental results, in the low temperature environment, the charging percentage threshold may be set to 98.73%, so that the image sticking immediately disappears.

In some embodiments, the charging percentage of the storage capacitor CS and/or the liquid crystal capacitor CL in the low temperature environment is achieved by increasing the driving frequency of the scanning lines S1 to SN. Table 3 shows the test results of the presence time of the image sticking at which the liquid crystal display 100 is tested when the ambient temperature is in normal temperature and when the ambient temperature is lower than the temperature threshold.

TABLE 3

| | | positive | | | | | |
|---|---|---|---|---|---|---|---|
| | | voltage | | | | | |
| | | of the | charging | | image sticking phenomenon | | |
| | driving | gate | percentage | | | | testing |
| model | frequency | electrode | 25° C. | −30° C. | 25° C. | −30° C. | condition |
| B | 60 Hz | 22 V | 99.17% | 84.48% | immediately | 10 minutes | 128 gray |
| | | | | | disappeared | | level |
| | 50 Hz | 22 V | 100% | 88.21% | immediately | 6 minutes | 128 gray |
| | | | | | disappeared | | level |
| | 30 Hz | 22 V | 100% | 97.01% | immediately | 1 minute | 128 gray |
| | | | | | disappeared | | level |
| | 20 Hz | 22 V | 100% | 99.38% | immediately | immediately | 128 gray |
| | | | | | disappeared | disappeared | level |
| | 20 Hz | 22 V | 100% | 99.38% | immediately | immediately | any gray |
| | | | | | disappeared | disappeared | level |

As shown in Table 3, in normal temperature, different driving frequencies are applied to the liquid crystal display 100 of the model B, and the charging percentage of the liquid crystal display 100 of the model B reaches 99.17% or more, so that the image sticking on the liquid crystal display 100 of the model B immediately disappears during the image sticking test with 128 gray level. However, when the temperature is lower than the temperature threshold (for example, −30 degrees Celsius), if the driving frequency of 60 Hz or 50 Hz is applied to the model B, when the liquid crystal display 100 of the model B is tested by the image sticking test with 128 gray level, the presence time of the image sticking is greater than the set time threshold (for example, 5 minutes). The charging percentage of the liquid crystal display 100 of the model B may reach 97.01% or more so that the presence time of the image sticking is less than the time threshold (for example, 5 minutes), when the drive frequency of 30 Hz or less is applied to the model B. According to the above experimental results, the present disclosure sets the charging percentage threshold to 97.01% in the low-temperature environment, so that the presence time of the image sticking is less than the time threshold (for example, 5 minutes).

In addition, as shown in Table 3, when the temperature is lower than the temperature threshold (for example, −30 degrees Celsius), if the driving frequency of 20 Hz is applied to the model B, the charging percentage of the liquid crystal display 100 of the model B may reach 99.38%, and the image sticking immediately disappears during the image sticking test with 128 gray level. In addition, when the driving frequency of 20 Hz is applied to the model B, the image sticking on the liquid crystal display 100 of the model B immediately disappears regardless of the gray level of the gray level screen. According to the above experimental results, in the present disclosure, in the low temperature environment, the charging percentage threshold may set to 99.38%, so that the image sticking immediately disappears.

The time threshold, the charging percentage threshold, and the temperature threshold as mentioned above are for illustrative purposes only and the present disclosure is not limited thereto.

The circuits and functions in the embodiments of present disclosure may be implemented by hardware, software or a combination of hardware and software such as microcontrollers, integrated circuits (ASICs), and programmable microcontrollers.

The liquid crystal display according to the present disclosure may improve the charging percentage of the capacitor in the low temperature environment by changing the pixel design parameter, the driving frequency and/or the positive voltage of the gate electrode, so that the charging percentage of the capacitor reaches the charging percentage threshold in a low temperature environment, and the image sticking phenomenon in low temperature environment is effectively improved.

What is claimed is:

1. A liquid crystal display, comprising a pixel array formed by a plurality of scanning lines and a plurality of data lines, wherein two of the scanning lines which are adjacent to each other and two of the data lines which are adjacent to each other form a pixel unit, and the pixel unit comprises:
a capacitor; and
a transistor, comprising:
a control terminal electrically connected to one of the scanning lines;
a first terminal electrically connected to one of the data lines; and
a second terminal electrically connected to the capacitor;
wherein when one of the scanning lines transmits a scanning signal to the control terminal of the transistor and turns on the transistor, one of the data lines charges the capacitor by transferring a data signal to the capacitor through the transistor, and the pixel unit still has a charging percentage greater than or equal to a charging percentage threshold when an ambient temperature is below a temperature threshold.

2. The liquid crystal display of claim 1, wherein the charging percentage threshold is between 90% and 99%.

3. The liquid crystal display of claim 2, wherein the charging percentage threshold is 90%.

4. The liquid crystal display of claim 2, wherein the charging percentage threshold is 98.73% or 98.75%.

5. The liquid crystal display of claim 1, wherein the temperature threshold is between −20 degrees Celsius and −40 degrees Celsius.

6. The liquid crystal display of claim 5, wherein the temperature threshold is −30 degrees Celsius.

7. The liquid crystal display of claim 1, wherein a ratio of a channel width of the transistor to a channel length of the transistor is 40.728/3.5.

8. The liquid crystal display of claim 1, wherein when the liquid crystal display is in an image sticking condition, a presence time of an image sticking on the liquid crystal display is less than a time threshold, wherein the image sticking condition comprises displaying a test screen on the liquid crystal display and maintaining the test screen for a period of time, changing a screen displayed on the liquid crystal display to a gray level screen, and detecting the presence time of the image sticking on the liquid crystal display.

9. The liquid crystal display of claim 8, wherein the time threshold is 5 minutes.

10. The liquid crystal display of claim 8, wherein a gray level of the gray level screen is between a minimum gray level and a maximum gray level of the liquid crystal display.
